(19) United States
(12) Patent Application Publication
(10) Pub. No.: US 2016/0107407 A1
(43) Pub. Date: Apr. 21, 2016

(54) METHOD FOR CONTROLLING A PRESS WITH A VARIABLE GEAR RATIO

(71) Applicant: SCHULER PRESSEN GMBH, Göppingen (DE)

(72) Inventor: Dieter Reisch, Göppingen (DE)

(21) Appl. No.: 14/894,008

(22) PCT Filed: May 21, 2014
(86) PCT No.: PCT/EP2014/060475

§ 371 Date: Nov. 25, 2015

(30) Foreign Application Priority Data
May 28, 2013 (DE) 10 2013 105 468.4

(51) Int. Cl. B30B 15/14; B30B 15/28; B30B 15/00

(52) U.S. Cl. CPC B30B 15/148; B30B 15/0094; B30B 15/281

(57) ABSTRACT

A method for controlling a press having an electric drive motor and a press transmission with a variable gear ratio (Ü) is disclosed. A tappet is movably mounted in a stroke direction (R) and is connected to the electric drive motor via the press transmission. The gear ratio (Ü) continuously increases as the tappet moves from an upper reversal point (OT) to a lower reversal point (UT). To prevent the press from exceeding a specified maximum pressing force (Fmax), a position-dependent maximum torque (Mmax) is specified for the motor. The control device compares each applied drive torque (M) with the maximum torque (Mmax). If the drive torque (M) exceeds the maximum torque (Mmax), the danger of the force applied by the tappet exceeding the maximum pressing force (Fmax) during an ongoing forming movement is detected. The control device then reduces the drive torque (M) to prevent damage to the press.

The present invention relates to a method for controlling a press. Herein, it is a press that operates in a path-dependent manner. The press comprises an electric drive motor that is disposed to move a ram back and forth in a stroke direction between an upper reversal point and a lower reversal point. To accomplish this, the electric drive motor is motion-coupled with the ram via a press transmission. The transmission has a variable gear ratio. The variable gear ratio changes, in particular, as a function of the position of the transmission parts or the position of the ram during its stroke movement. Such press transmissions may be, for example, an eccentric transmission or toggle-lever transmission. In these transmissions, the gear ratio is very high in the region of the lower reversal point and increases arithmetically towards infinity.

Presses comprising an electric drive motor have been known. For example, publication DE 10 2010 006 120 A1 describes a press comprising a power-assisted extractor and an articulated drive. Referring to these presses, the provision of overload protection in the form of pressure cushions has been suggested.

Publication DE 102007 026 727 A1 describes a press with power-assisted motors, wherein, for example, hydraulic cushions can be provided as overload protection.

In a method for actuating a press as known from publication DE 10 2005 040 263 A1 the ram drive is position-controlled during its working movement or its upward movement. With the tool closed, the control is switched from a positional control to a torque control or force control.

Considering this, the object of the present invention may be viewed to be the suggestion of an improved method for operating a press, said method reliably avoiding too high a pressing force in order to prevent damage to the press.

This object is achieved by a method displaying the features of Patent Claim 1.

As stated in the beginning, the press comprises a press drive with at least one electric drive motor and a press transmission that establishes a motion coupling between the drive motor and the ram. The ram can be moved back and forth in a stroke direction between an upper reversal point and a lower reversal point.

Referring to the method according to the invention, a maximum pressing force—also referred to as the nominal pressing force—is initially specified for the press. Subsequently, a position-dependent maximum torque for the at least one electric drive motor is determined as a function of the maximum pressing force and the variable gear ratio. The gear ratio is a function of the position of the ram during its stroke movement or of a press angle that has been specified for controlling the press. The press angle describes a complete movement of the ram from its upper reversal point into the lower reversal point and back to the upper reversal point, wherein the press angle changes from 0° to 360°. Depending on the kinematics of the press transmission, the lower reversal point may be associated with a press angle of approximately 180°. In as much as the gear ratio changes during the stroke movement of the ram, the maximum torque is specified as a function of the stroke position or as a function of the press angle.

The position-dependent maximum torque describes—for each stroke position or for each press angle—a drive torque for the electric drive motor that must not be exceeded in order not exceed the maximum pressing force during the continued movement of the stroke movement of the ram. If the drive torque of the at least one electric drive motor exceeds the maximum torque, it is found that—with continued movement of the ram and the drive motor using the specified drive torque—the maximum pressing force would be exceeded.

The position-dependent varying gear ratio and the nominal value of the drive torque of the at least one electric drive motor are known. This allows the determination of a progress for a maximum torque as a function of the press angle or the ram position that is exceeded before the maximum pressing force is exceeded. This may occur, for example, if several metal sheets are inadvertently placed into the press or if the operator of the press has performed the stroke adjustment wrongly, i.e., the position of the lower reversal point. If the drive torque exceeds the maximum torque, i.e., the danger is detected in time before the maximum pressing force is exceeded and a suitable measure may be initiated in order to safely prevent any damage to the press. Preferably, in the determination of the position-dependent maximum torque at least one parameter stating the frame spring of the press will also be taken into consideration. As a result of this, it is possible to determine for each press angle or for each ram position, a maximum torque for the electric drive motor, which, when exceeded, indicates that during a continued stroke movement of the ram from the upper reversal point into the lower reversal point an exceeding of the maximum pressing force is to be expected.

For example, the press transmission may comprise an eccentric gear or a toggle mechanism. In particular, the press transmission has a gear ratio that increases when the ram approaches the lower reversal point. Due to this changing gear ratio it is thus not sufficient to monitor the motor torque. The increasing gear ratio increases greatly toward the lower reversal point and is arithmetically infinitely large in the lower reversal point. Therefore, extremely minimal drive torques of the electric drive motor are sufficient for exceeding the maximum pressing force near the lower reversal point. For this reason the press angle or the ram position, and thus the transmission position, are included in the determination of a position-dependent maximum torque, so that any damage to the press can be effectively prevented.

In the preferred embodiment, the position-dependent maximum torque is specified for the entire stroke of the ram or for each press angle to be between 0° and 360°. As an alternative thereto, it could be sufficient to specify the position-dependent maximum torque at least within a nominal force path during the movement of the ram from the upper reversal point into the lower reversal point in one section of movement until the lower reversal point is reached. The nominal force path may have a length of a few millimeters up to one centimeter of the ram movement, measured in stroke direction.

It is advantageous if the drive torque of the at lest one electric drive motor is reduced once it is found that the danger of exceeding the maximum torque exists. The danger of exceeding the maximum torque is detected in particular in that the actual drive torque of the at least one electric drive motor is greater than the detected position-dependent maximum torque. For example, it is possible to reduce the motor current or to completely switch it off.

When the danger that a maximum torque might be exceeded is detected, the ram can also be actively decelerated via the electric drive motor. For example, to do so, the at least one electric drive motor may be switched to its generator mode. Alternatively or additionally, it is also possible to energize the at least one drive motor to generate a braking force. In so doing, the drive motor is energized—as it were—in such a manner that it attempts to reverse its direction of rotation and thus generates a braking force that acts on the ram.

If the drive torque exceeds the maximum torque, the ram can be decelerated relative to its specified ram movement and, in a preferred embodiment, be moved into a reference position. The reference position is, in particular, the upper reversal point. As a result of this, the press is brought into a defined state. By lifting the ram into the reference position or the upper reversal position, access to the workpiece is made possible. The operator can examine the cause for the threatening exceeding of the maximum pressing force and eliminate the problem.

In a preferred embodiment of the method an optical and/or acoustic alarm signal is generated when the drive torque exceeds the position-dependent maximum torque.

Furthermore, it is advantageous if changes of the drive torque occurring during the determination of the maximum torque are taken into consideration, said changes being caused by specified accelerations of the ram. Depending on the motion characteristic of the tapped stored in the press control, drive torque changes may be necessary during the stroke movement of the ram in order to adapt the time-dependent or press-angle-dependent position and/or velocity of the ram to the specified nominal values. Any velocity change, i.e., speed increases or speed decreases, is viewed as an acceleration of the ram. For example, depending on the forming task of the press it is possible to vary the rotational speed of the at least one electric drive motor during a stroke in order to achieve an acceleration in the specified sections of movement. However, these changes of the drive torque do not lead to the occurrence of the danger of exceeding the maximum pressing force because these drive torque changes effect a change of the kinetic energy of the ram. Therefore, it is advantageous to take into consideration such drive torque changes specified by the ram motion characteristic or the resultant drive torque changes in the determination of the position-dependent maximum torque. As a result of this, the precision of the method can be increased and inaccurate evaluations of the occurring pressing force are avoided.

The changes of the drive torque occurring due to the acceleration of the ram, which changes can be taken into consideration for the determination of the maximum torque, are such drive torque changes that occur independently of the forming work performed by the press. Such changes of the drive torque can be determined, for example, based on the specified ram motion characteristic. This ram motion characteristic can be obtained, for example, from the simulation of the press method or from the press control.

Additionally or alternatively, changes of the drive torque occurring due to the acceleration of the ram during a stroke can also be determined during a test stroke or a no-load stroke. As explained, these changes can be determined with the use of the ram characteristic based on a simulation or based on a no-load stroke before the first startup of the press.

In particular during the determination of the position-dependent maximum torque, an additional stroke-rate-dependent parameter is taken into consideration in addition to the changes of the drive torque that result from an acceleration of the ram independent of its forming work. As the stroke rate increases so does the acceleration of the ram which is taken into consideration by the stroke-number-dependent parameter. The stroke-rate-dependent parameter can thus form a factor that can be multiplied with the drive torque changes occurring independent of the forming work.

Advantageous embodiments of the invention can be inferred from the dependent patent claims and the description. The description is restricted to essential features of the invention. The drawings are to be used for supplementary reference. Hereinafter, exemplary embodiments of the invention are explained in detail with reference to the appended drawings. They show in

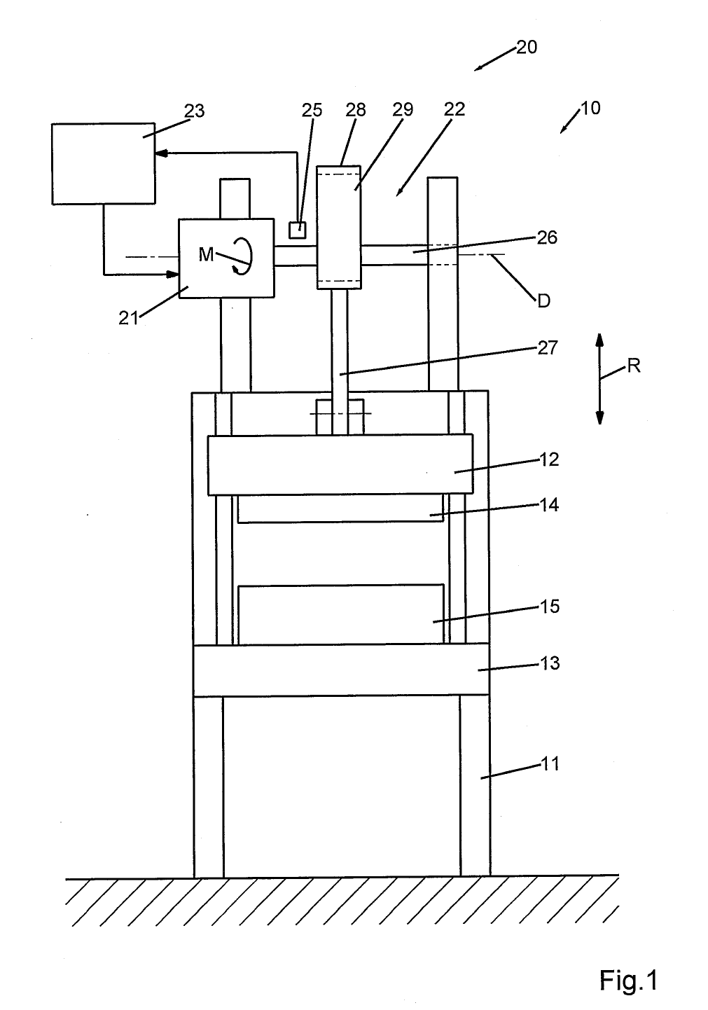

FIG. 1 a schematic representation resembling a block diagram of an exemplary embodiment of a press;

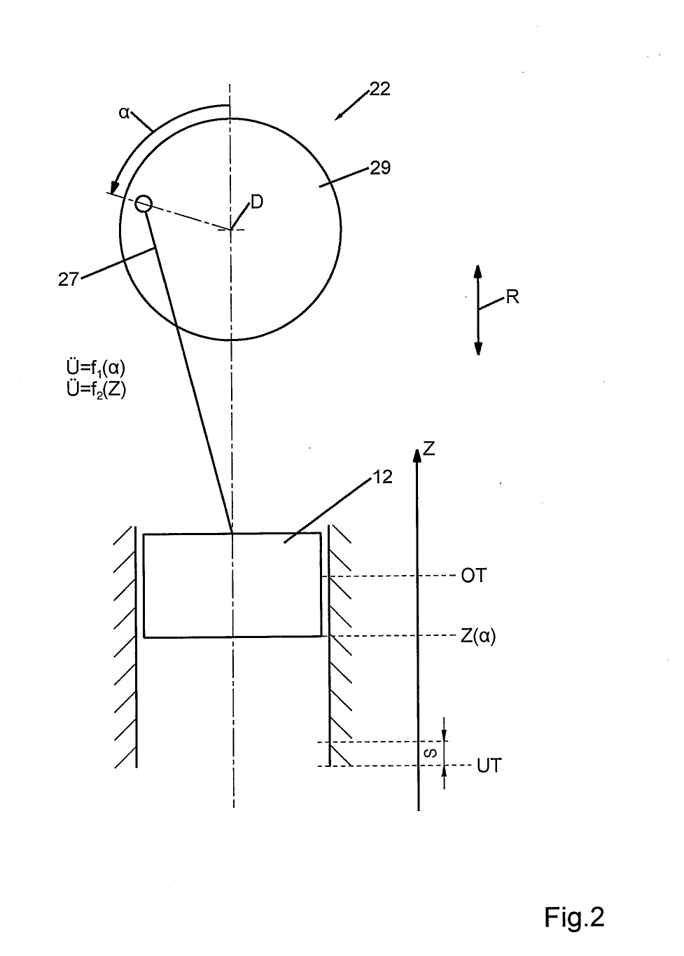

FIG. 2 a schematic diagram of the principle of the relationship between the press angle and the ram movement;

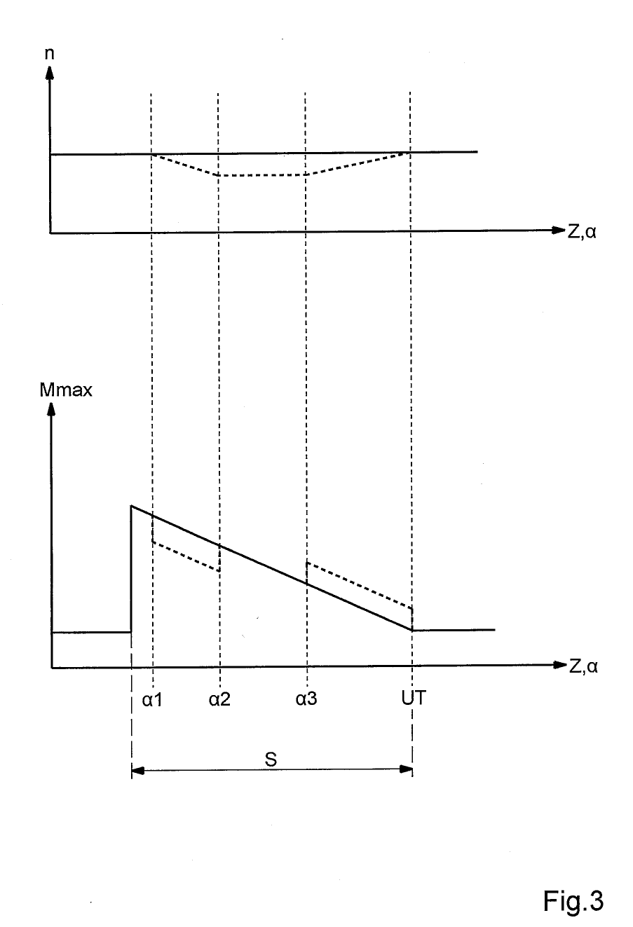

FIG. 3 a highly schematic exemplary progression of the rotational speed of the electric drive motor of the press, as well as the determined maximum torque in a nominal force path; and

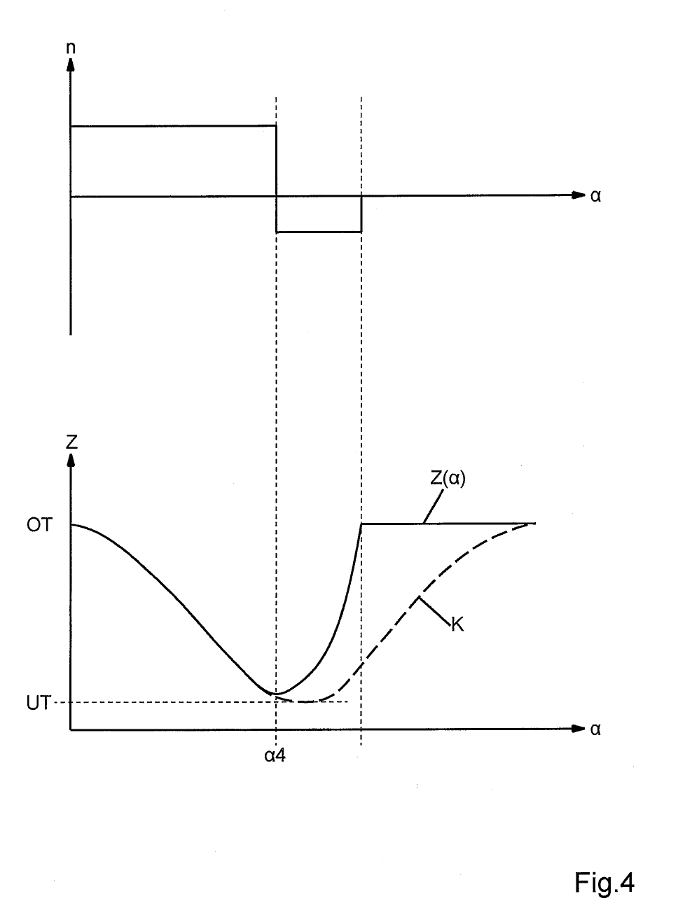

FIG. 4 a highly schematic exemplary representation of the chronological progression of the rotational speed of the electric drive motor as well as the ram movement.

FIG. 1 shows a press 10 operating in a path-dependent manner, comprising a press frame 11. A ram 12 is supported by the press frame 11 so as to be movable in one stroke direction R. A press table 13 is arranged on the press frame 11. The ram 12 bears an upper tool 14, and a lower tool 15 is arranged on the press table 13. The two tools 14, 15 interact to shape a not illustrated workpiece. To accomplish this, the ram 12 with the upper tool 14 can be moved toward the press table 13 or toward the lower tool 15.

A press drive 20 is disposed for moving the ram 12. The press drive 20 comprises at least one electric drive motor 21, as well as a press transmission 22. Hereinafter, it is assumed as an example that a single drive motor 21 is provided. However, the required drive torque for the press 10 can also be achieved by a combination of several drive motors. A control device 25 is disposed for controlling or regulating the at least one electric drive motor 21.

The press transmission 22 does not have a constant, specified gear ratio but a variable gear ratio Ü. The gear ratio Ü is a function of the ram position Z of the ram 12 viewed in stroke direction R or a function of a press angle α. The press angle α is disposed for describing a complete stroke of the ram 12, starting from an upper reversal point OT up to a lower reversal point UT, in which the ram 12 is at the smallest distance from the press table 13, and back to the upper reversal point OT. An exemplary progress of a complete stroke is shown in dashed lines in FIG. 4. Inasmuch as the press angle α and the ram position Z are in a specified relationship, the gear ratio Ü may be stated as a first function f₁ of the press angle α or as a second function f₂ of the ram position Z.

Referring to the exemplary embodiment of the press drive 22 shown here, the gear ratio Ü increases continuously during the movement of the ram 20 from the upper reversal point OT into the lower reversal point UT and moves toward an infinite value. In the exemplary embodiment according to FIGS. 1 and 2, the press 10 comprises an eccentric mechanism that displays such a transmission characteristic. Also, in the case of a toggle mechanism or a crank mechanism, the gear ratio Ü is position-dependent or path-dependent and not constant over the progression of a stroke.

In order to detect the actual position of the ram 12 or to detect the transmission angle α, the press 10 has a position sensor 25. The position sensor 25 can be assigned to the ram 12 and/or a transmission component of the press transmission 23 and/or to the electric drive motor 21. For example, the position sensor 25 is able to detect the rotatory position of the input shaft 26 of the press transmission 22, as is schematically illustrated by FIG. 1.

The specific design embodiment of the press transmission 22 may vary. For example, the ram 12 can be hinged to a ring 28 via a connecting rod 27, in which case the ring 28—in turn—is rotatably arranged on a cam 29 that is eccentrically driven by the input shaft 26. As an alternative to this embodiment shown in FIG. 1, the connecting rod 27 may also be hinged to the cam 29 eccentrically relative to the input shaft (FIG. 2). In this case, the cam 29 may also be arranged concentrically with respect to the input shaft 26 or the axis of rotation D.

Considering such presses 10, there is the danger that—due to the prevailing gear ratio Ü that is very high in certain sections of movement of the ram 12—an excessive pressing force is generated that could damage the press 10. In order to avoid this, a maximum pressing force Fmax is specified. The maximum pressing force may also be referred to as the nominal force of the press 10. Additionally, the nominal force path s in which the maximum pressing force Fmax may occur may be specified. The nominal force path s terminates in the lower reversal point UT of the ram 12 and may have a length of 5 to 6 mm, for example, i.e., measured in stroke direction R. Thus, also the energy that can be maximally retrieved from the press 10 during the forming process can be determined via the nominal force path s and the maximum pressing force Fmax.

As a function of this maximum pressing force Fmax and the position-dependent gear ratio Ü a position-dependent maximum torque Mmax is determined or computed. The maximum torque Mmax represents a limiting value for the drive torque M of the electric drive motor 21. In this manner, the monitoring of the drive torque M for each ram position Z or for each press angle a allows the determination whether there is the danger that the maximum pressing force Fmax will be exceeded during the continued ram movement in accordance with a ram characteristic specified by the control device 23 as well as by the specified drive torque M. Consequently, it is ensured that, by comparing the drive torque with the maximum torque Mmax, it is possible to detect already at a press angle α or a ram position Z that there is the danger of an exceeding of the maximum pressing force Fmax, before this is actually the case. In this manner, it is possible to initiate measures that effectively prevent the force applied by the ram 12 from exceeding the maximum pressing force Fmax.

In other words, the drive torque M applied by the electric drive motor 21 already exceeds the determined maximum torque Mmax before the force applied by the ram 12 has reached the maximum pressing force Fmax. This can be determined with the known gear ratio Ü, the specified maximum pressing force Fmax, the known ram movement and, preferably additionally, based on at least one frame spring parameter describing the frame spring of the press 10. The frame spring parameter describes the elastic frame spring of the press while the workpiece is being formed. In the press 10 operating in a path-dependent manner, the frame spring depends on the forming path of the ram 12 from the time the workpiece is set down to the upper reversal point UT.

FIG. 3 shows, in an exemplary manner, a greatly simplified progression of the maximum torque Mmax. The position-dependent maximum torque Mmax may be specified for the entire stroke of the ram 12 from the upper reversal point OT into the lower reversal point UT and back to the upper reversal point OT. At least the progression for the maximum torque Mmax in the region of the nominal force path s is determined and monitored. In the simplest case, the maximum torque Mmax is specified on the basis of a constant rotational speed n for the electric drive motor 21, as is schematically illustrated by solid lines in FIG. 3. The maximum torque Mmax increases rapidly to a maximum value at the start of the nominal force path s and then decreases again at a numerically smaller slope to the lower reversal point UT. A sawtooth-shaped progression as indicated highly schematically in FIG. 3 is the result.

As an alternative thereto, it is also possible to take into consideration changes of the rotational speed n of the drive motor 21 and thus accelerations of the ram 12 in determining the maximum torque Mmax, as is illustrated by the sections marked by dashed lines in FIG. 3. Such rotational speed changes can be specified, depending on the forming task, by a motion characteristic of the ram 12 and be stored in the control device 23. The control device energizes the drive motor 21, so that the ram 12 will move consistent with the specified motion characteristic K. A simple motion characteristic K for a constant rotational speed n is shown as an example in dashed lines in FIG. 4.

Rotational speed changes of the drive motor 21 that are specified by the motion characteristic K for the ram 12 also lead to the change of the drive torque M provided by the electric drive motor 21. Inasmuch as such changes do not substantially influence the pressing force applied by the ram 12 in the path-dependent press 10, they are taken into consideration in a preferred exemplary embodiment of the invention in the determination of the maximum torque Mmax. Consequently, incorrect evaluations regarding an impending exceeding of the maximum pressing force Fmax can be avoided.

Referring to FIG. 3, it is only assumed as an example, that—at a first press angle α1—the rotational speed n of the electric drive motor decreases to a second press angle α2. In doing so, the ram 12 is decelerated. The value and/or the direction of the drive torque M of the electric drive motor 21 change accordingly. In order to take into consideration this acceleration of the ram 12, the maximum torque Mmax in the range between the first press angle α1 and the second press angle α2 is decreased by the amount by which, depending on the acceleration of the ram 12, the drive torque M of the electric drive motor 21 is changed. FIG. 3 shows the change of the maximum torque Mmax in dashed lines.

Referring to the example depicted in FIG. 3, it is further assumed as an example that, starting with a third press angle α3 up to the lower reversal point UT, the rotational speed n of the electric drive motor 21 is increased. In order to accelerate the ram 12 accordingly, an increased drive torque M of the electric drive motor 21 is necessary. The maximum torque Mmax is increased by a value that corresponds to the value of the change of the drive torque M, which is also indicated in dashed lines in FIG. 3.

Consequently, changes of the drive motor M that lead to the acceleration of the ram 12 and are specified independent of the forming working by a motion characteristic K for the ram 12, for example, are taken into consideration in the determination of the position-dependent maximum torque Mmax. The value and the progression of the rotational speed n and the resultant, occurring rotational speed changes may be different depending on the forming task of the press 10 and are only shown in a simplified exemplary manner by FIG. 3. However, non-linear rotational speed progressions may also occur.

The maximum torque Mmax can be computed for the ram position at the start of the nominal force path s, for example, as follows:

Assumptions:

Nominal force path s=8 mm,

Press angle at the start of the nominal force path αₛ=9°,

Eccentric radius r=650 mm,

Maximum pressing force Fmax=18,000 kN,

Gear ratio Ü(αₛ)=17.

The path c covered by the eccentric on its eccentric radius about the axis of rotation of the eccentric then is as follows:

c=r*sin(αₛ) .

The maximum torque Mmax at a press angle α=αₛ then is as follows:

$$M max ( {α}_{s} ) = \frac{c * F max}{\ddot{U} ( {α}_{s} )} .$$

With the aforementioned numerical values the maximum torque Mmax=108,000 Nm in accordance with the example.

The control device 23 compares the actual drive torque M applied by the electric drive motor 21 with the determined position-dependent maximum torque Mmax. As soon as the drive torque M exceeds the maximum torque Mmax, the danger of exceeding the maximum pressing force Fmax is detected. If the motor torque exceeds the value of 108,000 Nm at the start of the nominal force path s, i.e., in the previously described example, the danger of exceeding the maximum pressing force Fmax is detected. At this time measures are initiated. In particular, the drive torque M of the electric drive motor 21 is reduced in order to reduce the force applied by the ram 12. Even if, due to the inertia and the velocity of the ram 12, an instant stopping of the ram 12 is not possible, it is possible—by reducing the drive torque M by a sufficient value taking into consideration the position-dependent gear ratio Ü—to prevent an exceeding of the maximum pressing force Fmax. The rotatory energy stored in the rotation is then converted into a springiness of the press, which spring energy can be computed in view of the rotatory energy and the stiffness of the press.

If the calculation shows that the exceeding of the maximum pressing force Fmax cannot be ensured by switching off the torque alone, preferably a breaking means of the press 10 is used in order to stop or even reverse the continued movement of the ram 12 more rapidly. For example, the electric drive motor 21 can be switched into its generator mode and act as brake means. Additionally or alternatively, it is also possible to provide other brake means such as a friction brake, for example.

Consequently, it is also possible to switch the electric drive motor 21 into its generator mode when the danger of an exceeding of the maximum pressing force Fmax was detected. Referring to the exemplary embodiment shown in FIG. 4, it is assumed that, with a fourth press angle α4, the actually applied drive torque M of the electric drive motor 21 exceeds the specified maximum torque Mmax. For example, the ram 12 is initially decelerated by a reversal of the direction of rotation of the electric drive motor 21 and moved back into the opposite direction. In fact, however, different from the only schematic depiction as in FIG. 4, there is no vertical slope for the rotational speed n. Initially, the moved mass must be stopped and accelerated in the opposite direction. Then the ram 12 is moved into a reference position that corresponds to the upper reversal point OT in the exemplary embodiment. The actual movement Z(α) of the ram 12 (solid line in FIG. 4) no longer follows the specified motion characteristic K in this case.

With the maximum torque of the drive motor 21 it is possible to calculate the maximum brake power as a function of the rotational speed and to determine therefrom the mean brake power. For example, the mean brake poser may be assumed to be half of the maximum brake power. As a function of the rotation energy it is then possible to calculate the required brake time and the angle difference of the press angle α or the ram path covered during the brake time.

As soon as this reference position is reached, the press is stopped 10. There may also be an optical and/or acoustic alarm. The operator of the press 10 can then search for the cause that has led to the danger of an exceeding of the maximum pressing force Fmax. This may be caused, for example, in that several metal sheets or workpieces were inadvertently placed in the press 10. Another error source may be that the ram stroke and thus the position of the lower reversal point UT was changed and adjusted too close to the press table 13 or the lower tool 15. This, too, can result in impermissibly high pressing forces.

The accelerations of the ram 12 that result independently of the forming work, for example, from a specified motion characteristic K for the ram 12, can be determined in various ways. For example, it is possible to obtain these accelerations and any resultant changes of the drive torque M of the electric drive motor 21 by simulating the operation of the press 10. As an alternative thereto, it is also possible at the time when the press 10 is set up to perform an no-load stroke without the insertion of a workpiece. The changes of the drive torque M occurring in conjunction with this can be determined and stored. Inasmuch as there is no workpiece, the changes of the drive torque M are due to the adjusted, specified motion characteristic K for the ram 12 and the resultant accelerations of the ram 12.

If, in this manner, the changes of the drive torque M that are not caused by forming but by specified desired accelerations of the ram 12 have been determined, they can be taken into consideration in the calculation of the position-dependent maximum torque Mmax, as was explained in conjunction with FIG. 3. These changes can also be adapted to various stroke rates for the press 10. In this case, additionally one stroke-rate-dependent parameter is taken into consideration in the determination of the position-dependent maximum torque Mmax, said parameter being, for example, a factor that is multiplied with the determined change of the drive torque M resulting from the simulation or the no-load stroke. As a result of this, accelerations having a higher value that result with an increase of the stroke rate of the press 10 are taken into consideration.

The invention relates to a method for controlling a press 10. The press 10 has an electric drive motor 21 and a press transmission 22 with a variable gear ratio Ü. A ram 12 of the press 10 is mounted in a movable manner in a stroke direction R and is connected to the electric drive motor 21 via the press transmission 22. The gear ratio Ü continuously increases and to a high degree as the ram moves from an upper reversal point OT to a lower reversal point UT. In order to prevent the press 10 from exceeding a specified maximum pressing force Fmax, a position-dependent maximum torque Mmax is specified for the electric drive motor 21. The control device compares each applied drive torque M with the position-dependent maximum torque Mmax. As soon as the drive torque M exceeds the position-dependent maximum torque Mmax, the danger of the force applied by the ram 12 exceeding the maximum pressing force Fmax during an ongoing forming movement is detected. The control device 12 then reduces the drive torque M in order to prevent damage to the press 10.

### LIST OF REFERENCE SIGNS

10 Press
11 Press frame
12 Ram
13 Press table
14 Upper tool
15 Lower tool
20 Press drive
21 Electric drive motor
22 Press transmission
23 Control device
25 Position sensor
26 Input shaft
27 Connecting rod
28 Ring
29 Cam
α Press angle
α2 First press angle
α2 Second press angle
α3 Third press angle
α4 Fourth press angle
D Axis of rotation
Fmax Maximum pressing force
K Ram motion characteristic
M Drive torque
Mmax Maximum torque
n Rotational speed
OT Upper reversal point
Ü Gear ratio
UT Lower reversal point
s Nominal force path
Z Ram position

1. A method for controlling a press (11) with an electric drive motor (21) that is connected via a press transmission (22) with a variable gear ratio (Ü) to a ram (12) that is supported so as to be movable in a stroke direction (R) between an upper reversal point (OT) and a lower reversal point (UT), and with a control device (23) that controls and regulates the electric drive motor (21), the method comprising:
presetting a maximum pressing force (Fmax) for the press (10);
determining a position-dependent maximum torque (Mmax) for the electric drive motor (21) as a function of the maximum pressing force (Fmax) and the gear ratio (Ü); and
controlling or feedback controlling the electric drive motor (21) in such a manner that the pressing force exerted by the ram (12) is smaller over an entire stroke movement than the maximum pressing force (Fmax).

2. The method as in claim 1, further comprising increasing the gear ratio (Ü) of the press transmission (22) as the ram (12) approaches the lower reversal point (UT).

3. The method as in claim 1, wherein the press transmission (22) comprises an eccentric transmission or a toggle lever transmission.

4. The method as in claim 1, further comprising specifying the position-dependent maximum torque (Mmax) at least within a nominal force path (s) up to the lower reversal point (UT).

5. The method as in claim 1, further comprising reducing a drive torque (M) of the electric drive motor (21) is reduced if it is detected that the maximum pressing force (Fmax) may be exceeded.

6. The method as in claim 1, further comprising decelerating the ram (12) if it is detected that the maximum pressing force (Fmax) may be exceeded.

7. The method as in claim 6, further comprising energizing the electric drive motor (21) counter to its actual direction of rotation in order to decelerate the ram (12).

8. The method as in claim 1, further comprising switching the electric drive motor (21) into a generator mode or actuating the electric drive motor (21) for generation of a brake force if it is detected that the maximum pressing force (Fmax) may be exceeded.

9. The method as in claim 1, further comprising moving the ram (12) into a reference position (OT) if it is detected that the maximum pressing force (Fmax) may be exceeded.

10. The method as in claim 1, further comprising, for determining the position-dependent maximum torque (Mmax), taking into consideration at least one parameter describing a cushioning of the press (10).

11. The method as in claim 1, further comprising, for determining the position-dependent maximum torque (Mmax), taking into consideration changes of a drive torque (M) specified by path-dependent accelerations of the ram (12).

12. The method as in claim 11, further comprising determining the changes of the drive torque (M) occurring due to accelerations of the ram (12) using a specified ram motion characteristic (K).

13. The method as in claim 11, further comprising determining the changes of the drive torque (M) occurring due to the accelerations of the ram (12) using with a no-load stroke of the ram (12).

14. The method as in claim 13, further comprising determining the position-dependent maximum torque (Mmax) based on the changes of the drive torque (M) detected during a no-load stroke of the ram (12) and based on a stroke-rate-dependent parameter.

15. An apparatus, comprising:
an electric drive motor (21);
a press transmission (22) with a variable gear ratio (Ü);
a ram (12) connected to the electric drive motor (21) via the press transmission (22), the ram (12) being movable in a stroke direction (R) between an upper reversal point (OT) and a lower reversal point (UT); and
a control device (23) configured to control, or feedback control, the electric drive motor (21) such that the pressing force exerted by the ram (12) over an entire stroke movement does not exceed a maximum pressing force (Fmax) by using a position-dependent maximum torque (Mmax) parameter for the electric drive motor (21) determined as a function of a maximum pressing force (Fmax) for the apparatus (10) and the gear ratio (Ü).

16. The apparatus of claim 15, wherein the control device is configured to reduce a drive torque (M) of the electric drive motor (21) if it detects that the maximum pressing force (Fmax) may be exceeded.

17. The apparatus of claim 15, wherein the control device is configured to move the ram (12) into a reference position (OT) if it detects that the maximum pressing force (Fmax) may be exceeded.

18. The apparatus of claim 15, where in the control device is configured to decelerate the ram 12 if it detects that the maximum pressing force (Fmax) may be exceeded.
